(19) United States
(12) Patent Application Publication
(10) Pub. No.: US 2018/0086858 A1
(43) Pub. Date: Mar. 29, 2018

(54) POLYMERIZATION OF MICHAEL-TYPE MONOMERS

(71) Applicant: Technische Universität München, München (DE)

(72) Inventors: Maximilian Knaus, München (DE); Marco Giuman, München (DE); Bernhard Rieger, Elchingen (DE)

(21) Appl. No.: 15/561,740

(22) PCT Filed: Mar. 24, 2016
(86) PCT No.: PCT/EP2016/056639

§ 371 Date: Sep. 26, 2017

(30) Foreign Application Priority Data
Mar. 27, 2015 (EP) 15161358.5

(51) Int. Cl. C08F 4/54; C08F 4/12; C08F 4/00; C08F 2/06; C08F 120/44; C08F 120/06; C07F 9/50

(52) U.S. Cl. CPC C08F 4/54; C08F 4/12; C08F 4/005; C08F 2400/02; C08F 120/44; C08F 120/06; C07F 9/50; C08F 2/06

(57) ABSTRACT

A process for precision polymerization is described using a system of a Lewis acid, a Lewis base and a Michael-type monomer that can form a frustrated triple, wherein a Michael-type monomer, optionally dissolved in an organic solvent, is reached with a Lewis acid to form at least one zwitterionic type complex, a Lewis base is added to form a frustrated triple with the zwitterionic type complex which initiates the polymerization reaction, and the reaction is continued to form a polymer.

The present invention is concerned with a process of polymerizing a Michael-type monomer in the presence of a catalyst and an initiator.

The polymerization of Michael-type based monomers, for example acryl-based monomers, like methylacrylate, is well-known and common technology, such as radical polymerization can be used. However, this common technology has its drawbacks and limitations. Radical initiated polymerizations are difficult to control with regard to tacticity and dispersity of polymers. Moreover, demanding monomers like acryl esters having bulky substituent groups, are difficult to polymerize and can be obtained only in low yields or with time and cost consuming processes. Tacticity and dispersity index are hardly or not to control for monomers like acrylonitrile. With the known methods such polymerization reactions could be controlled only by using catalysts comprising noble metals or rare earth metals which cause high cost and are detrimental for the environment.

In the last few years main group element catalysis experienced renaissance due to the seminal work of Erker and Stephan (see for example S. Grimme et al., Angewandte Chemie International Edition 2010, 49, 1402-1405; D. W. Stephan, G. Erker, Angewandte Chemie International Edition 2010, 49, 46-76). They found that frustrated Lewis pairs exhibit unique properties and can be used for some reactions as catalysts. The cooperative interaction of sterically encumbered frustrated Lewis pairs enables for example the activation of small molecules like H₂, CO₂ or SO₂. The first observation of the phenomenon of frustrated Lewis pairs was reported by Brown et al. in 1942 (H. C. Brown et al., JACS 1942, 64, 325-329), with the interaction of 2,6-lutidine and different boranes. Whereas lutidine forms a classical Lewis pair adduct with BF₃, it does not react with the sterically more demanding BMe₃. A first application of this system for heterolytic hydrogen cleavage was conducted by Stephan et al. in 2010. Chen et al. introduced frustrated and classical Lewis pairs in the field of polymer chemistry (Y. Zhang et al., Angewandte Chemie 2010, 122, 10356-10360). They successfully achieved the polymerization of methyl methacrylate, α-methylene-γ-butyrolactone, and γ-methyl-α-methylene-γ-butyrolactone by conjugate-addition polymerization. However, this method is limited to less hindered acrylate systems, where activation proceeds via carbonyl or imine complexation, as has been reported by Y. Zhang et al. (Dalton transactions 2012, 41, 9119-9134, Synlett 2014, 25, 1534).

When Zhang's system is used for sterically and/or electronically demanding monomers like diethylvinylphosphonate, high polydispersity is obtained. This is due to the process used according to Zhang et. al. which does not allow any control over the polymerization process. Furthermore Zhang's system is not suitable to polymerize sterically challenging monomers like furfurylmethacrylate (Dalton transactions 2012, 41, 9119-9134). Although sterically demanding monomers like n-butyl methacrylate can be polymerized using Zhang's system, only very low yields and broad dispersities are obtained.

Acryl-based polymers have been prepared in technical processes using free radical polymerization. Examples are the production of polymethacryl acid methyl ester (PMMA), or polyacrylonitrile (PAN). Those polymers are well-known and are used for example as fibers, in paints and dyes. The use of free radicals for polymerization, however, yields polymers with high polydispersity and the reaction is difficult to control. Many attempts have been made to find alternative processes to control the reaction of acrylic monomers. In one approach, acrylic polymers were made by using pure acrylonitrile in solution using the so-called RAFT-technology. This technique, however, does not allow to produce polyacrylonitrile with higher molecular weight but yields polymers with a molecular weight of about up to 16,000 g/mol and with a low molecular weight distribution of about 1.1 (see C. Tang et al., Macromolecules 2003, 36, 8587-8589).

On the other hand, it was possible to obtain polyacrylonitrile having high molecular weight (such as Mn>200,000 g/mol) with a lower polydispersity index (PDI 1.7-2.0) by using bis(thiobenzoyl)disulfide or bis(thiophenylacetoyl)disulfide. The use of activators for regeneration of RAFT-reagents allows to obtain polymers having a higher molecular weight, however, long reaction times are necessary, the yield is low and reagents for reduction which are expensive and partially toxic, like Sn-(2-ethylhexanoat) have to be applied.

Chen et al. used Lewis pairs for polymerization to overcome these disadvantages. It was assumed by Chen et al. that the polymerization occurs via a zwitter ionic intermediate structure, wherein the Lewis acid activates the monomer and the Lewis base binds to the activated monomer. Although some acrylic monomers could be polymerized with this technology, it was not possible to use this described process for polymerization of acrylonitrile or for sterically hindered acrylate esters. Thus, the Lewis pairs proposed by Chen et al. for polymerization could be used only for specific monomers, but not for sterically or electronically demanding monomers.

As outlined in Zhang et al. (see above) it was not possible to react furfurylmethacrylate, and n-butylmethacrylate could be reacted by using Lewis pair catalysis only with a yield of 35%. It is assumed that the low activity is caused by deactivation of the catalyst.

Therefore, it was the object of the present invention to provide a new method for precision polymerization of sterically and/or electronically demanding Michael-type monomers, such as acrylates having at least one bulky group, acrylonitrile, or heteroalkyl or heterocyclic substituted monomers, in higher yields and in shorter time periods than in the prior art.

It was surprisingly found, that the above mentioned problems are solved by using a method and a catalyst system as defined in the claims and in particular by using a specific frustrated triple system of a Lewis acid as catalyst, a Lewis base as initiator and a Michael-type monomer as starting system for polymerization. The process of the present invention allows to polymerize sterically demanding monomers as well as very electron poor and electron rich monomers in a very efficient manner with control of molecular mass, dispersity and tacticity. For example, with the system of the present invention it is possible to polymerize furfuryl methacrylate in good yield whereas this was not possible with a prior art method (see Zhang above).

The inventors found that the unpredictable or unsatisfying results obtained with the methods of the prior art are caused by a combination of catalyst and monomer which does result in catalyst blocking and/or insufficient or uncontrollable polymerization.

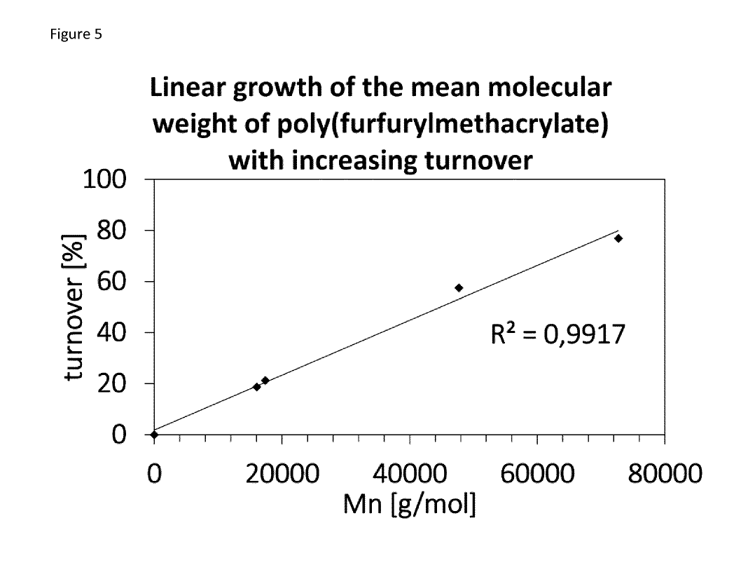

The present invention provides a precision polymerization method which allows a controllable polymerization. Furthermore, a living-type polymerization of demanding monomers can be carried out, where linear growth of the mean molecular mass of a polymer is observed by increasing turnover, as can be seen in FIG. 5 and example 6. This is possible by using the catalyst system of the present invention wherein the reactive partners are selected according to their electronic state such that they can form a frustrated triple.

Thus, it is the gist of the present invention that the system of monomer—Lewis acid—Lewis base is adjusted such that a frustrated triple is built which allows polymerization with high efficiency. Furthermore, adjusting the system allows controlling the polymerization with regard to polydispersity and molecular mass.

According to one aspect, the present invention provides a process for precision polymerization using a frustrated triple system of a Lewis acid, a Lewis base and a Michael-type monomer, wherein a) a Michael-type monomer, optionally dissolved in an organic solvent, is reacted with a Lewis acid to form at least one zwitter ionic type complex, b) a Lewis base is added to form a frustrated triple with the zwitter-ionic type complex, which initiates the polymerization reaction, and c) the reaction is continued to form a polymer,

wherein the Lewis acid is XₐMR₃₋ₐ, wherein M is AI, B, Ga, or In; wherein each X independently is Cl, F, I, Br; each R independently is linear, branched, or cyclic alkyl, alkenyl, alkinyl, or alkoxy, heterocycloalkyl, heterocycloalkenyl, heterocycloalkinyl, aryl, heteroaryl, aryloxy, silyl, metallocenyl, nitro, nitroso, hydroxy, or carboxyl, wherein each alkyl, alkenyl or alkinyl group independently has up to 12, preferably up to 8 carbon atoms, wherein each aryl independently has 6 to 10 carbon atoms, wherein any hetero group has at least one hetero atom selected from O, S or N; wherein each alkyl, alkenyl, alkinyl, or alkoxy, heterocycloalkyl, heterocycloalkenyl, heterocycloalkinyl, aryl, heteroaryl, aryloxy group can be substituted by 1 up to the highest possible number of halogen atoms or by at least one unsubstituted or halogensubstituted linear, branched or cyclic alkyl group having up to 6 carbon atoms, and wherein a is an integer from 0 to 3, and wherein if a is 1, X can be hydrogen; and
wherein the Lewis base is PZ₃, wherein each Z independently is a linear, branched, or cyclic alkyl, alkenyl, or alkinyl group, or heteroalkyl, heteroalkenyl, or heteroalkinyl, group, having up to 12 carbon atoms; or a donor substituted aryl or hetero aryl group having 6 to 10 carbon atoms, with the proviso that the tolman angle of the base is 180° or less; wherein any hetero group comprises at least one hetero atom selected from O, S or N.

The term “frustrated triple” as used in the present invention refers to a system that is comprised of three components, i.e. a Lewis acid, a Lewis base and a Michael-type monomer, wherein Lewis acid and Lewis base are adapted such that all three components form an associated product including a zwitter-ionic system, wherein the stability of the system is such that the association of the Lewis acid is strong enough to initiate polymerization but not strong enough to allow a permanent binding. A test for determining this property is described below. It is this specific frustrated triple system that provides for a starting point for a polymerization reaction and for a controlled polymerization. Only when this combination of the three components forming a frustrated triple is used, the favorable properties of the present invention are obtained. Only when the three components build a frustrated triple, sterically and/or electronically demanding monomers can be polymerized in an effective and controllable way.

It was found that electronically and/or sterically demanding Micheal-type monomers can be polymerized by adapting the catalyst system and allowing the formation of a “frustrated triple”. In particular, the reactivity of the Lewis acid/Lewis base/monomer system can be adjusted by choosing the electronic state of Lewis acid and Lewis base in consideration of the monomer(s) to be reacted. If an electron deficient monomer shall be polymerized, an electron withdrawing Lewis acid should be used, as the coordination is not high enough, to block the catalyst. If, on the other hand, electron-rich or electron excessive monomers, like tert.-butyl methacrylate are polymerized, a Lewis acid should be used as catalyst which does not strongly withdraw electrons, as otherwise the coordination between both reaction partners is too strong and blocks any further reaction.

The term “precision polymerization” as used in the present application refers to a highly efficient polymerization method yielding polymers with a low or very low polydispersity index. In particular, this term refers to a polymerization reaction which is controllable by the type, binding partner and amount of catalyst. It allows to produce polymers of a predetermined length and allows to produce polymers having a monomodal molecular mass distribution.

The term “electronic state” as used in the present application refers to the electronic state of a monomer i.e. excess or deficiency of electrons. Electron deficient monomers can for example be created by adding electron withdrawing substituents, such as nitrilo, and monomers with excess electrons can for example be created by adding electron donating or low electron withdrawing groups, like phosphonato.

According to the present invention a frustrated triple system is built by the process as described in detail below, wherein the Lewis acid activates the monomer such that an electrophilic site is created which then can combine with a nucleophilic Lewis base to form the frustrated triple. To allow the components to form a frustrated triple system, the three components have to be adapted to each other. If the monomer is electron-rich, the Lewis acid shall not be highly acid but have only medium to low acidity. If on the other hand the monomer is electron-deficient, a medium to highly acid, preferably highly acid Lewis acid is necessary. In other words, the more electron-rich the monomer is, the lower the acidity of the Lewis acid shall be. A highly acid Lewis acid and a highly electron-rich monomer cannot be used together in the polymerization process of the present invention because they will not form a frustrated triple system. Highly electron-rich monomers and highly acid Lewis acids have a too strong association with each other to allow the formation of an active frustrated system. On the other hand an electron deficient Lewis acid and an electron deficient monomer will form no or a weak coordination. If the coordination between monomer and Lewis acid is too weak, when adding a Lewis base this might be attracted by the Lewis acid and combine with it without monomer, so that no catalytic effect occurs.

Furthermore, steric hindrance is an important factor when adapting the system. If a monomer has sterically demanding groups like tertiary butyl groups, the Lewis acid shall not carry bulky groups. On the other hand, if a monomer does not comprise sterically bulky groups, like acrylonitrile, the Lewis acid can comprise bulky groups. If both, the monomer and the Lewis acid carry bulky groups, the coordination between both is too weak to allow, together with the Lewis base, the formation of a frustrated triple.

Lewis acids that are particularly useful for the precision polymerization are aluminum based acids having an acidity which lies between Al(C₆HaI₅)₃ having high acidity, and Al(tert.-butyl)₃ having low acidity. For each monomer the suitable Lewis acid can be selected based on its acidity. The Lewis acid can be symmetric or asymmetric. The symmetry or asymmetry of the Lewis acid can be used to provide or control tacticity, i.e. to allow formation of isotactic or syndiotactic polymers.

The Lewis acid is one with formula XₐMR₃₋ₐ, wherein M is Al, B, Ga, or In; each X independently is Cl, F, I, Br, each R independently is linear, branched, or cyclic alkyl, alkenyl, alkinyl, or alkoxy, heterocycloalkyl, heterocycloalkenyl, heterocycloalkinyl, aryl, heteroaryl, aryloxy, silyl, metallocenyl, nitro, nitroso, hydroxy, or carboxyl, wherein each alkyl, alkenyl or alkinyl group independently has up to 12, preferably up to 8 carbon atoms, wherein each aryl independently has 6 to 10 carbon atoms, wherein any hetero group has at least one hetero atom selected from O, S or N; wherein each alkyl, alkenyl, alkinyl, or alkoxy, heterocycloalkyl, heterocycloalkenyl, heterocycloalkinyl, aryl, heteroaryl, aryloxy group can be substituted by 1 up to the highest possible number of halogen atoms or by at least one unsubstituted or halogensubstituted linear, branched or cyclic alkyl group having up to 6 carbon atoms, and wherein a is an integer from 0 to 3, and wherein if a is 1, X can be hydrogen.

Alkyl, alkenyl, alkinyl, or alkoxy groups can be linear, branched, or cyclic and can have up to 12 carbon groups. Linear alkyl and alkoxy groups can have 1 to 12 carbon atoms, linear alkenyl or alkinyl groups can have 2 to 12 carbon atoms, branched or cyclic alkyl, alkenyl or alkinyl groups and linear, branched or cyclic alkyl, alkenyl, alkinyl and alkoxy groups can have 3 to 12 carbon atoms.

The carbon containing groups R in the formula can be partially or fully halogenated, such as perfluorinated. The term “wherein each alkyl, alkenyl, alkinyl, or alkoxy, heterocycloalkyl, heterocycloalkenyl, heterocycloalkinyl, aryl, heteroaryl, aryloxy group can be substituted by 1 up to the highest possible number of halogen atoms” refers to such groups that can carry only one halogen, in particular chlorine, fluorine or bromine, or more halogen atoms. Any possible number of halogen atoms can be present on a group and the “highest possible number of halogen atoms” refers to groups wherein each hydrogen has been replaced by a halogen atom, in other words that are perhalogenated.

“Halogensubstituted linear, branched or cyclic alkyl groups” refers to alkyl groups that are substituted by one or more halogen atoms, such as perfluorinated alkyl groups.

Examples for an aryl group are phenyl and naphthyl. A halogen substituted phenyl group is a phenyl carrying 1 to 5, in particular 3 to 5 halogens, such as fluoro. A halogen substituted cycloalkyl group can be a C₃-C₈ cycloalkyl group carrying 1 to 3-8 halogens, in particular 3 to 5 halogens, such as fluoro. The halogen substituted heteroaryl group is a heteroaryl carrying 1 to 5, in particular 3 to 5 halogen atoms, such as fluoro. Similarly, for example an aryl group substituted with at least one unsubstituted or halogensubstituted alkyl group can carry 1 or more such groups up to the highest possible number of such groups. Examples are phenyl or naphthyl substituted by one or more methyl, perfluoro-methyl, ethyl, or perfluoro-ethyl groups.

The compounds can have 1, 2, or 3 groups R which can be the same or different. An example for a useful Lewis acid is an aluminum compound carrying 3 phenyl groups.

In one embodiment the Lewis acid is an aluminum compound XₐAlR₃₋ₐ, wherein R is phenyl, halogen substituted phenyl, alkyl, such as methyl, ethyl, propyl, iso-butyl or tert.-butyl, or alkoxy, such as isopropoxy. It has been found that triphenyl aluminum, trimethyl aluminum, tri-isobutyl aluminum, and aluminum isopropoxide are very useful catalysts in the system of the present invention. Groups X and R in the formula account for acidity and steric hindrance, these groups are selected based on the electronic and sterical properties of the monomer.

As outlined above, the Lewis acid is selected based on the monomer to be polymerized. If the monomer is electron deficient, like acrylonitrile, a Lewis acid with high to medium acidity is chosen. In this case an acid like triphenyl aluminum is useful and allows for high turnover rates and high activity. If the monomer is electron rich, a Lewis acid with medium to low acidity like trimethyl aluminum, triethyl aluminum or tert. butyl aluminum can be chosen.

Whereas AlCl₃, a commonly used catalytic compound cannot provide a polymerization of monomers such as acrylonitrile or acrylates having bulky groups. The provision of an aluminum compound as defined above, is a useful catalyst with extraordinary high turnover frequencies (TOF). An aluminum compound as defined above with three carefully selected groups is extremely active as catalyst, can build a frustrated triple with Lewis bases and monomers of the present invention, and is in particular useful for the polymerization of difficult monomers, like electron deficient and/or sterically demanding monomers.

The second part of a frustrated Lewis triple used according to the present invention is a phosphine base that also has to be adapted to the system. Phosphine bases are known and are commonly used as catalysts and have also been tested as one partner of a frustrated Lewis pair for catalysis. However, it has been described that for example PPh₃ does not provide fast reactions and high activity when used with more demanding monomers. Without being bound by theory, it is assumed that the Lewis base in the system of the present invention does not act as a catalyst, but as initiator.

A Lewis base useful for the system of the present invention is a compound PZ₃, wherein each Z independently is a linear, branched, or cyclic alkyl, alkenyl, or alkinyl group, or heteroalkyl, heteroalkenyl, or heteroalkinyl group, having up to 12 carbon atoms; or a donor substituted aryl or hetero aryl group having 6 to 10 carbon atoms, with the proviso that the tolman angle is 180° or less; wherein any hetero group comprises at least one hetero atom selected from O, S or N. It is a compound that has three substituents which are either donor substituted aryl groups or alkyl groups wherein the tolman angle is 180° or less. The tolman angle can be determined as is known to the skilled person and as is described in Chemical Reviews, 1977, vol. 77, pages 313-348. The Lewis base is adapted such that a frustrated triple can form with a given monomer and a correspondingly selected Lewis acid.

The phosphine used in the frustrated Lewis pair of the present invention carries three groups Z, which are selected from saturated or unsaturated, linear, branched or cyclic alkyl or heteroalkyl groups. The three groups Z can be identical or different. Preferably, the phosphine has three identical groups. It has been found that cycloalkyl groups having 3 to 8, preferably 4 to 6 carbon atoms, such as cyclopentyl or cyclohexyl, are particularly useful. Moreover, it has been found that saturated or unsaturated alkyl groups, either linear or branched, combined with a Lewis acid as defined above, surprisingly are active as initiator for polymerization of demanding monomers. In preferred embodiments tricyclohexylphosphine, trimethylphosphine or triethylphosphine are used as sterically encumbered Lewis bases. The selection of the base is critical, as it was found that the nucleophilicity and the electronic properties of the Lewis base have a high influence on the reactivity.

A Lewis base with a nucleophilicity that is optimally suited for a combination with a monomer and a Lewis acid that has been selected as above, and forms a frustrated triple as defined, can be found by using a method as described below.

According to one aspect of the present invention the Lewis acid and the Lewis base that are used for the frustrated triple system are part of a frustrated Lewis pair (FLP). A frustrated Lewis pair is a pair of a Lewis acid and Lewis base which due to sterical hindrance cannot combine and undergo a neutralization reaction. Thus, both, Lewis acid and Lewis base, are available without reacting with each other. In last years it was found that these frustrated Lewis pairs have interesting properties and can react in an unusual way. Thus, in the present application a frustrated Lewis pair means a combination of a Lewis acid and a Lewis base which cannot undergo a neutralization reaction because of sterically hindering groups.

The monomer to be polymerized is a Michael-type monomer. The term “Michael-type monomer” refers to compounds that have a vinylogous part, i.e. either an α,β-ethylenically unsaturated group, a triple bond or a double bond within a cyclic or aromatic group in conjugation to an electron withdrawing group. Electron withdrawing groups are known to the skilled person and those that are well-known are carbonyl, sulfonyl, phosphonyl among others. In one aspect the monomer is a compound that has a keto enolate tautomery, such as acrylates and acrylate esters or vinylketons. In other words, the monomer to be used according to the present invention is characterized by a vinylogous part, which allows the transmission of electronic effects through conjugated bonds. Examples for vinylogous compounds are acrylates as defined below, acrylonitrile, vinylphosphonates such as diethylvinylphosphonate (DEVP) or vinylsulfonates.

The method of the present invention is particularly useful for the polymerization of electronically and/or sterically demanding monomers, such as monomers having bulky groups and/or monomers that are electron-deficient or electron-poor. In the present application bulky groups means groups that have a size, dimension, or electron density, respectively, that prevents chemical reactions that are observed in related molecules having smaller groups. Steric hindrance can occur by the size of a group, by hindrance of rotation of other groups, and/or by restriction of torsional bond angles.

It has been found by the inventors of the present invention that by using a frustrated triple system, i.e. by adapting three components, namely Lewis acid, Lewis base and Michael-type monomer, otherwise difficult to polymerize compounds can be activated and polymers can be obtained in a fast and controlled reaction. Moreover, it has been found that control of the reaction is possible by adapting steric and electronic properties of a Lewis base and Lewis acid, by adapting the percentage of Lewis base and Lewis acid and/or the organic solvent to influence the polymerization reaction. By adapting the above mentioned parameters, polydispersity, molecular weight, and tacticity can be controlled.

Without being bound by theory, it is assumed that the polymerization of Michael-type monomers is enabled by forming a frustrated triple system. In a first step a Lewis acid which is adapted regarding acidity to the monomer is combined with the monomer. The Lewis acid associates with the electron withdrawing group of the monomer, for example the carbonyl group, the sulfonyl group or the phosphonate group and draws electrons from the conjugated double or triple bond via a mesomeric system. By this association an electrophilic active site is created.

A Lewis base which is adapted regarding nucleophilicity is then added to the complex of Lewis acid and monomer. The Lewis base is a phosphine having an active electron pair, i.e. a nucleophilic site which combines with the electrophilic site of the Lewis acid/monomer complex. This results in a frustrated triple system which is very active and which can be formed only when the reactivity of Lewis acid and Lewis base are adapted to the monomer to avoid strong bonds between each of the components and to allow enough activity at the relevant site, i.e. the carbon atom which reacts with another monomer. This frustrated triple is the starting point for the polymerization. It reacts with a monomer and as soon as the bond between both monomers has been built, the Lewis acid is discharged and moves to the electron withdrawing group of the next monomer and again activates the carbon atom at the conjugated double bond. It is this mechanism which allows for polymerization of normally difficult to polymerize monomers. Both, the Lewis base and the Lewis acid provide for the activation of the site where bonding occurs. If Lewis acid and Lewis base are not adapted, they either cannot be split off or react with each other which cannot result in activation of the monomer.

The process of the present invention can be carried out in the presence of an organic solvent. The term “organic solvent” as used in the present application refers to a compound that is liquid at room temperature and/or process temperature. Organic solvents are very well-known in the art. An organic solvent in the process of the present invention can have different functions: it can be used as inert carrier that not necessarily dissolves any of the three components; it can be used to dissolve the monomer; it can be used as heat dissipating agent. Furthermore, the polarity of the solvent can have an influence on the tacticity. Thus, in cases where tacticity is an issue the polarity of the solvent has to be considered and a suitable solvent has to be selected.

In one embodiment a process of polymerizing an acryl-based monomer in the presence of a catalyst and an initiator is provided, wherein the catalyst is AlR₃, wherein R is as defined above, and the Lewis base is a phosphine PZ₃, wherein each Z is defined as above, in particular wherein each Z independently is a linear alkyl group having 1 to 10 carbon atoms, a branched alkyl group having 3 to 10 carbon atoms or a cycloalkyl group having 3 to 8 carbon atoms, and wherein the monomer is selected from acrylonitrile or an acryl ester C(R¹R²)═C(R³)—C(O)—OR⁴, wherein R¹, R², R³, and R⁴ are independently selected from hydrogen, C₁-C₆-alkyl, aryl, heteroaryl wherein at least one of R¹, R², R³, or R⁴ is a bulky group.

According to one aspect of the present invention tert.-butyl methacrylate can be polymerized with the system of the present invention and it is possible to obtain poly-tert.-butyl methacrylate having a high molecular weight, a low dispersity, and a high percentage of tacticity. Such a poly-tert.-butyl methacrylate was not available with the methods known in the prior art. Therefore, one aspect of the present invention is a poly-tert.-butyl methacrylate having a molecular weight of more than 100,000 g/mol and a percentage of syndiotacticity of at least 30%, or even more than 50%, preferably 60% or more.

According to another aspect of the present invention acrylonitrile can be polymerized with the system of the present invention and it is possible to obtain a polyacrylonitrile having a high molecular weight, a low dispersity, and a percentage of tacticity. Such a polyacrylonitrile was not available with the methods known in the prior art. Therefore, one aspect of the present invention is a polyacrylonitrile having a molecular weight of more than 100,000 g/mol and a percentage of tacticity, in particular syndiotacticity of at least 30%, or even more than 35%.

It is one of the key features of the present invention to find the optimal components for forming the frustrated triple system. Therefore, it is another object of the present invention to provide a method for selecting components for a frustrated triple system.

This method comprises that it is determined if a monomer which shall be polymerized, is electron-rich or electron-poor, select a Lewis acid which for an electron deficient monomer has high acidity and for an electron-rich monomer has low acidity, and combine the selected Lewis acid with the monomer, add a phosphine that is adapted sterically and/or regarding its nucleophilicity and start polymerization and determine dispersity index, molecular weight, tacticity, structure, and/or turn over frequency of the polymerization.

The method for determining a system according to the present invention, thus, comprises the step, that the polymer obtained after a predetermined time period is analyzed regarding dispersity index, molecular weight, tacticity and/or structure. These parameters can be determined as known to the skilled person. The polymers can be characterized by ¹H- and ¹³C-NMR spectroscopy as well as GPC analysis. Absolute molecular weights can be determined by multi angle laser light scattering (MALLS-GPC). One method for determining the structure, i.e. the tacticity is nuclear magnetic resonance.

It was found that a combination of a Lewis acid and a Lewis base as defined above, when used as catalyst system results in a polymerization reaction with high turnover rates, wherein a nearly quantitative monomer consumption is obtained within very short time, such as only 15 minutes at room temperature, and wherein a polymer with high polymer weight and a suitable polydispersity, such as about 2 or less, could be obtained.

Comparison tests were made with Lewis acids and Lewis bases that were known in the prior art and were used for polymerization as mentioned above, and it was found that only when using the selected partners of the frustrated triple of the present invention the favourable results can be obtained.

Moreover, it was found that the ratio of Lewis acid and Lewis base has an influence on turnover frequency and molecular mass and that by increasing the amount of Lewis base the activity of the catalyst system can be drastically increased and high turnover frequency can be obtained. Thus, by adapting the ratio of acid and base molecular mass, polydispersity index (PDI) and turnover rate can be adjusted. It has been found that when using a higher amount of Lewis acid the reaction can be well controlled but can be slow, if the amount of Lewis acid is low, the reaction can be fast and difficult to control. If the amount of Lewis base is too high, the reaction can be out of control.

Thus, in general the ratio of base to acid can be in a range of about 0.1-10:1, or 0.5-6:1. The higher the percentage of base is, the more difficult control of the reaction becomes. Therefore, a preferred ratio is in a range of about 0.1-1:1, more preferred 0.1-0.5:1.

Thus, if the polydispersity index is too high, the ratio of Lewis base to Lewis acid can be decreased. The lower the ratio is, the lower the polydispersity index is. If Lewis base and Lewis acid are used in a molar ratio of about 0.1-1:1, good results can be obtained. When the ratio of Lewis base to Lewis acid is about 0.1-0.5:1, polymers having medium molecular mass but low PDI are obtained, whereas polymers having a higher molecular mass and a broader PDI are obtained with a molar ratio of about 0.5-1:1.

Thus, by adapting the ratio of Lewis base and Lewis acid the polydispersity index and in particular the molecular mass can be adapted accordingly. The catalyst activity is increased dramatically when the Lewis base is in excess, which results in a high increase of turnover frequency but also loss of control.

Furthermore, it was found that catalyst activity, polymer yield, molecular mass of the final polymer, and polydispersity index are dependent from the molar ratio of monomer to catalyst system, in other words from the catalyst loading. It was found, that a high catalyst loading, i.e. a molar ratio of monomer/catalyst of less than 1,000 results in a high yield, nearly stoichiometric monomer consumption and a low molecular mass.

Thus, by using the catalyst system of the present invention it is possible depending on the desired final product to adapt the catalyst system. According to one embodiment of the present invention, where polymers having a lower molecular mass are required, a low base/acid ratio and a high catalyst loading is applied.

The catalyst system of the present invention is active in a broad temperature range. Polymerization reactions can be conducted with this polymer system in a range of −115° C. to 150° C. In most cases, the catalyst of the present invention is active at room temperature, thus can be used without heating or cooling. Activity can be increased, by lowering the temperature to 0° C. or below and very favorable results can be obtained. High conversion rates are obtained between about 0° C. and room temperature, i.e. 25° C. Thus, although the catalyst system can be used in a broad temperature range, in a preferred embodiment the method is carried out at a temperature between −10° C. and 25° C., preferably between 0 and 25° C. The optimal temperature can be found in routine tests depending from catalyst system, monomer and solvent used.

The reaction usually is carried out in a fluid medium which can be an organic solvent which dissolves the monomer, in a salt melt, or a gas. Organic solvents that are usable for the preparation of polymers from acryl-based monomers are known and those that are used in the prior art can be used for the process of the present invention, too. Usually aromatic or aliphatic hydrocarbons, heteroaromatic and heteroaliphatic compounds, as long as they are liquid at process temperature, or ionic solvents are suitable. Also salt melts as well as supercritical CO₂ can be used. Aromatic hydrocarbons that are very common in this field are preferred, such as toluene which is particularly useful.

The amount of solvent is the amount that is usually used. By increasing or decreasing the amount of solvent, the activity and the duration can be influenced as is well-known to the skilled person.

The process of the present invention can be used to polymerize acryl-based monomers that in the past could be reacted only using free radicals. The present invention is particularly suitable for the polymerization of acrylonitrile, an economically very valuable monomer, and for dimensionally demanding acryl-based monomers having at least one bulky substituent.

Polyacrylonitrile has great importance for the production of synthetic fibers. Nevertheless, a controlled synthesis of polyacrylonitrile was limited to controlled radical reaction pathways like ATRP, NMP, or RAFT. These synthesis methods have some disadvantages. They show very slow monomer conversion, which excludes them from industrial application. In contrast thereto, the system of the present invention allows a rapid controlled conversion to produce polyacrylonitrile fibers and provides a new pathway to carbon fiber precursors which benefit from a high molecular mass and a narrow molecular mass distribution.

Another valuable group of polymers are those that are produced from acryl-based monomers with bulky groups. It has been found that the catalyst system used in the present invention allows to polymerize monomers of the formula C(R¹R²)═C(R³)—C(O)—OR⁴, wherein R¹, R², R³, and R⁴ are independently selected from hydrogen or methyl, aryl, heteroaryl or a bulky group, wherein at least one of groups R¹ to R⁴ is a bulky group, such as tert.-alkyl, for example tert.-butyl, cycloalkyl, for example cyclohexyl or cyclo-octyl, phenyl or mesityl, naphthyl.

In one embodiment monomers are used wherein R¹, R², and R³, are hydrogen, or methyl, and R⁴ is a bulky group. In another embodiment monomers are used wherein R³ is hydrogen or methyl and at least one of R¹, R² and R⁴ is a bulky group.

In one preferred embodiment tert.-butylmethacrylate was used as monomer. It was possible to produce the polymer with a yield of more than 90% at room temperature or below.

The method of the present invention allows the synthesis of high molecular weight polymers with extraordinary high turnover rates. The conversion is extremely fast and the polymeric material obtained has a high weight average molecular weight between 10⁴ and 10⁶ g/mol. The obtained polymers were characterized by ¹H- and ¹³C-NMR spectroscopy as well as GPC analysis. Due to the overestimation of mean molecular weights by conventional calibration methods, multi angle laser light scattering (MALLS-GPC) was used to determine the absolute molecular weights. Thus, molecular weights mentioned in this application have been obtained by MALLS-GPC.

The catalyst system of the present invention is very active and allows fast conversion. Thus, polymers can be obtained within very short time which makes the process of the present invention industrially applicable.

The drawings show analytical data of polymers obtained with the method of the present invention, wherein

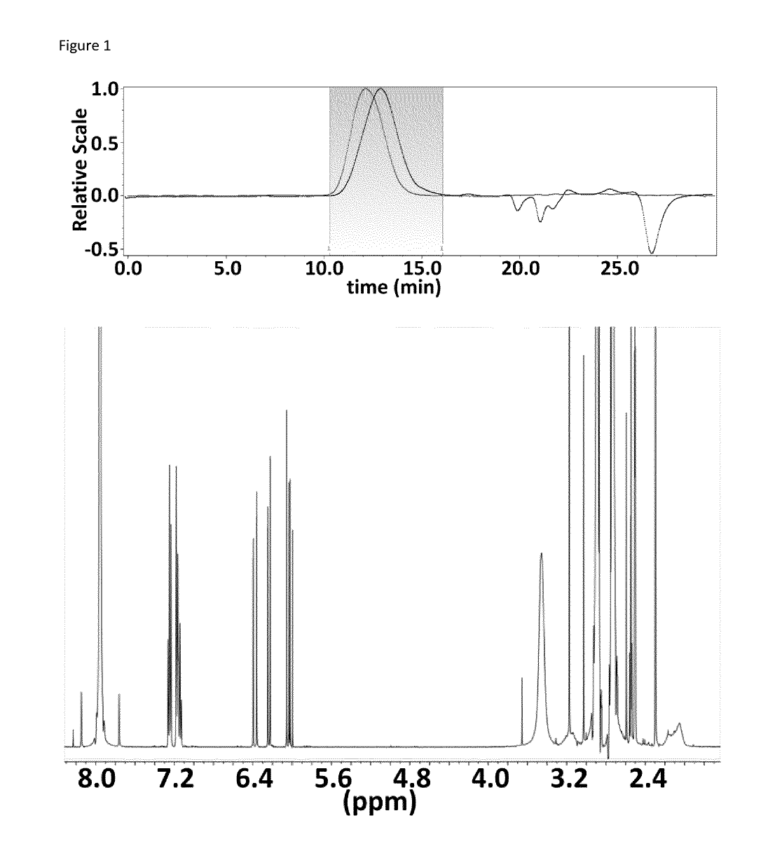

FIG. 1 shows the GPC spectrum and the NMR spectra of the polymer obtained in example 1.

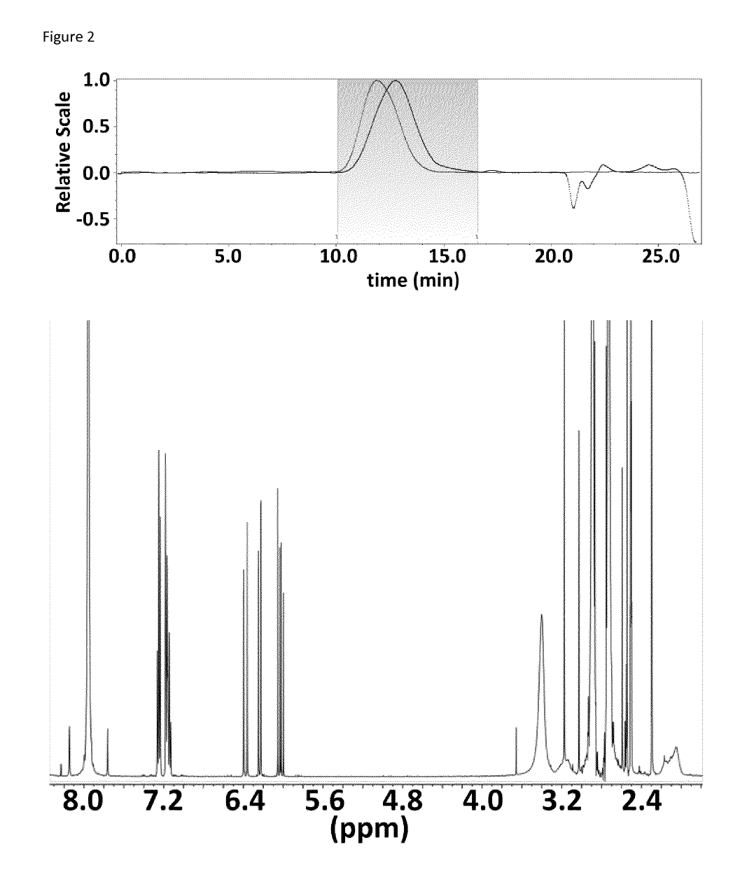

FIG. 2 shows the GPC spectrum and the NMR spectra of the polymer obtained in example 3.

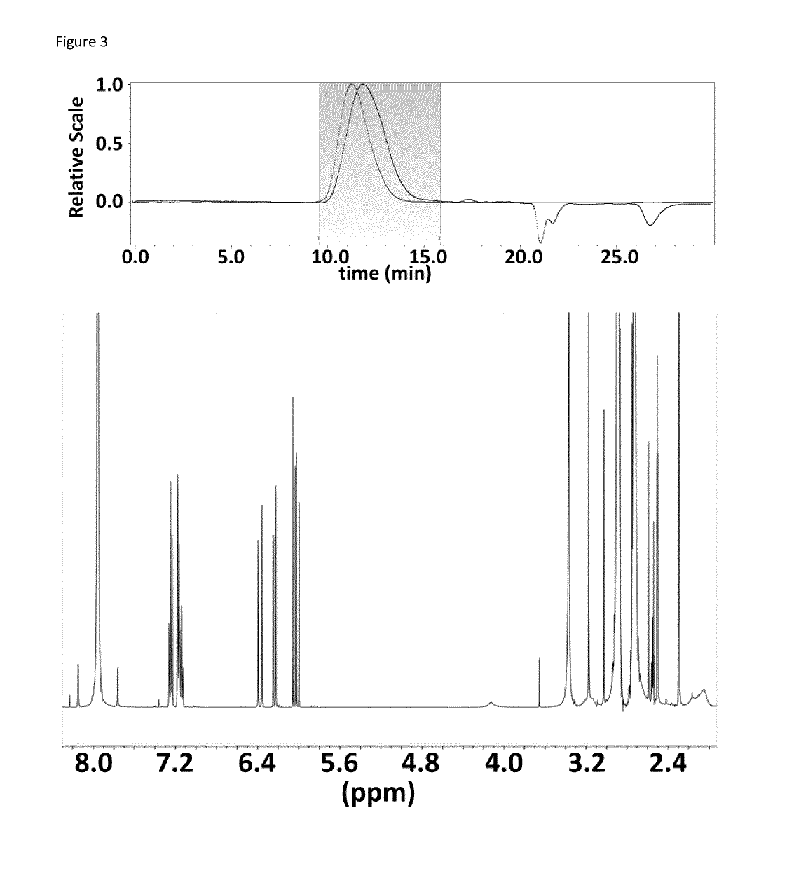

FIG. 3 shows the GPC spectrum and the NMR spectra of the polymer obtained in example 4.

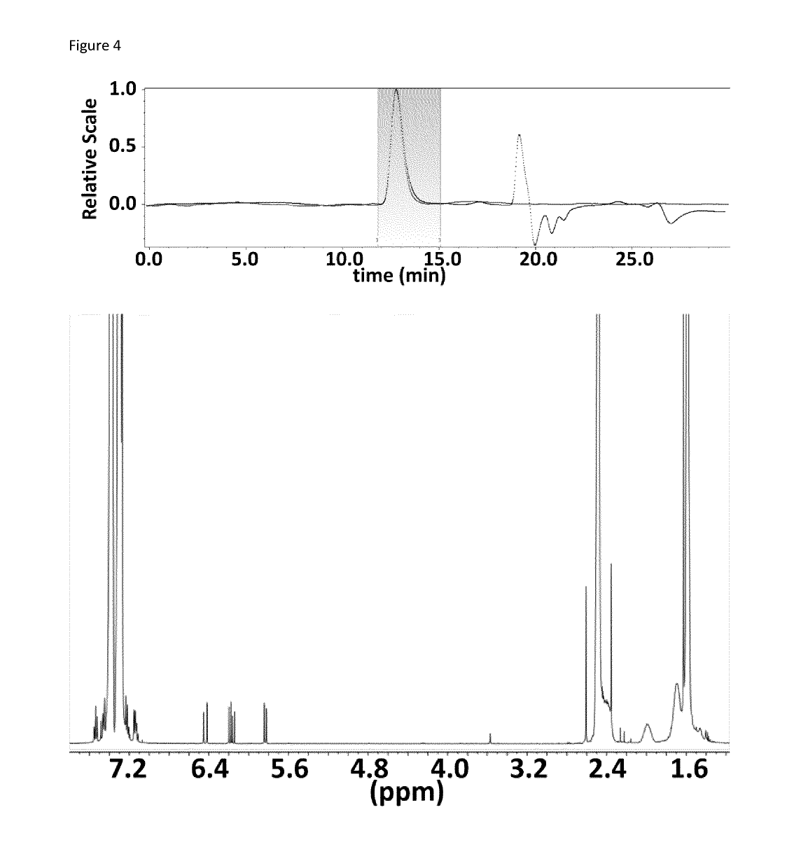

FIG. 4 shows the GPC spectrum and the NMR spectra of the polymer obtained in example 5.

FIG. 5 shows linear growth of the mean molecular mass of poly(furfurylmethacrylate) with increasing turnover.

Gel permeation chromatography detection was made using a WTC Dawn Heleos II MALS detector. GPC was carried out on a Varian LC-920 system with two PL polar gel columns and N,N-dimethyl formamide (0.025 M LiBr) (polyacrylonitrile) or tetrahydrofurane (poly(tert.-butylmethacrylate)) were used as liquid medium. The retention times were recorded via a MALLS detector and via an integrated RI detector (356-LC). The GPC spectrum is shown in FIG. 2.

The NMR spectra were recorded with an AV III 500C of Bruker and were evaluated with Top Spin 3 software.

In the following examples specific embodiments of the present invention are shown without thereby limiting the scope of the invention.

### EXAMPLES

Acrylonitrile was polymerized using a frustrated triple system. The conditions and results are shown in Table 1. The method is described in detail below.

TABLE 1
Selected results of the polymerization of acrylonitrile with Al(R)₃ × Tol/Lewis base

| | | | | | Reaction | | | | Mₙ × 10⁴ | | |
|---|---|---|---|---|---|---|---|---|---|---|---|
| | | | [Base]/ | [Monomer]/ | volume | Temp | t | Yield^{[a]} | [B] | PDI | |
| Run | Acid | Base | [Acid] | [Cat] | [mL] | [° C.] | [min] | [%] | [g/mol] | [B] | TOF |
| 1 | Al(Me)₃ | PEt₃ | 1 | 2000 | 7.5 | 0 | 15 | 42 | 1.9 | 1.97 | 3360 |
| 2 | AlCl₃ | PCy₃ | 1 | 500 | 7.5 | 0 | 15 | — | — | — | — |
| 3 | Al(Et)₃ | PCy₃ | 1 | 2000 | 7.5 | 0 | 10 | 47 | 2.2 | 2.04 | 5640 |
| 4 | Al(Ph)₃ | PCy₃ | 1 | 2000 | 7.5 | 0 | 10 | 37 | 5.2 | 1.75 | 4440 |
| 5 | Al(OiPr)₃ | PCy₃ | 0.1 | 100 | 7.5 | 0 | 10 | 87 | 25.3 | 1.53 | 5220 |
| 6 | Al(Ph)₃ | PMe₃ | 1 | 2000 | 7.5 | 0 | 10 | 45 | 4.6 | 1.62 | 5400 |

^{[a]}Yields determined by ¹H-NMR spectroscopy of sample aliquots and of the isolated polymers determined by using gravimetric methods.
[B] Mₙ and PDI determined using multi angle laser light scattering (MALLS) detection methods.

### Example 1

Polyacrylonitrile was produced using a catalyst system of the present invention. The reaction was performed in oven-dried glass reactor Al(Me)₃ (302 μL, 12.5 mmol/L solution in toluene) was added and cooled to 0° C. Acrylonitrile (500 μL, 3.77 mmol, 400 mg, 2,000 equivalents) and thereafter triethylphosphine (PEt₃) (151 μL, 25.0 mmol/L solution in toluene, 1 equivalents) were added and the mixture was stirred for 15 min at 0° C. The reaction was stopped by adding a mixture of DMF-MeOH—HCl (100:10:1). A sample was taken and an ¹H-NMR was recorded. Thereafter, the polymer was precipitated in 40 mL MeOH. Centrifugation, washing a few times with each 10 mL MeOH, centrifugation and drying at 40° C. (12 h) in high vacuum yielded 169 mg (42%) polyacrylonitrile. The analytical data are shown in FIG. 1.

### Example 2 (for Comparison)

Polyacrylonitrile was produced using a catalyst—AlCl₃—as known in the prior art. The reaction was performed in oven-dried glass reactor AlCl₃ (302 μL, 12.5 mmol/L suspension in toluene) was added and cooled to 0° C. Acrylonitrile (500 μL, 3.77 mmol, 400 mg, 2,000 equivalents) and thereafter tricyclohexylphosphine (PEt₃) (151 μL, 25.0 mmol/L solution in toluene, 1 equivalents) were added and the mixture was stirred for 15 min at 0° C. The reaction was stopped by adding a mixture of DMF-MeOH—HCl (100:10:1). A sample was taken and an ¹H-NMR was recorded. The reaction yielded no polymer.

### Example 3

Polyacrylonitrile was produced using a catalyst system of the present invention. The reaction was performed in oven-dried glass reactor Al(Et)₃ (302 μL, 12.5 mmol/L solution in toluene) was added and cooled to 0° C. Acrylonitrile (500 μL, 3.77 mmol, 400 mg, 2,000 equivalents) and thereafter triethylphosphine (PEt₃) (151 μL, 25.0 mmol/L solution in toluene, 1 equivalents) were added and the mixture was stirred for 15 min at 0° C. The reaction was stopped by adding a mixture of DMF-MeOH—HCl (100:10:1). A sample was taken and an ¹H-NMR was recorded. Thereafter, the polymer was precipitated in 40 mL MeOH. Centrifugation, washing a few times with each 10 mL MeOH, centrifugation and drying at 40° C. (12 h) in high vacuum yielded 189 mg (47%) polyacrylonitrile. The analytical data are shown in FIG. 2.

### Example 4

Polyacrylonitrile was produced using a catalyst system of the present invention. The reaction was performed in oven-dried glass reactor Al(Ph)₃ (302 μL, 12.5 mmol/L solution in toluene) was added and cooled to 0° C. Acrylonitrile (500 μL, 3.77 mmol, 400 mg, 2,000 equivalents) and thereafter tricyclohexylphosphine (PCy₃) (151 μL, 25.0 mmol/L solution in toluene, 1 equivalents) were added and the mixture was stirred for 15 min at 0° C. The reaction was stopped by adding a mixture of DMF-MeOH—HCl (100:10:1). A sample was taken and an ¹H-NMR was recorded. Thereafter, the polymer was precipitated in 40 mL MeOH. Centrifugation, washing a few times with each 10 mL MeOH, centrifugation and drying at 40° C. (12 h) in high vacuum yielded 149 mg (37%) polyacrylonitrile. The analytical data are shown in FIG. 3.

### Example 5

Tert.-butylmethacrylate was polymerized using a catalyst system of the present invention. The reaction was performed in a glovebox. Toluene (1.85 mL) and Al-Me₃ (620.0 μL, 25 mmol/L solution in toluene) were added to an oven-dried glass reactor. Tert.-butylmethacrylate (500 μL, 3.07 mmol, 437 mg, 200 equivalents) and PEt₃ (310.0 μL, 25 mmol/L solution in toluene, 0.5 equivalents) were added and immediately stirred for 90 min at room temperature. The reaction was stopped by adding a mixture of MeOH—HCl (100:10) and a ¹H-NMR was recorded and the obtained polymer was lyophilized. 406 mg (93%) poly(tert.-butylmethacrylate) were obtained. The analytical data are shown in FIG. 4.

### Example 6

Further polymerization reactions were performed analoguously as described in example 5 using furfuryl methacrylate as another demanding monomer. The results are shown in the table 2. As can be seen in table 2, the catalyst system of the present invention provides for a “living-type” polymerization, i.e. poly(furfuryl methacrylate) can be produced with a linear growth of the mean molecular mass of the polymer with increasing turnover, as is also shown in FIG. 5. This is in contrast to the teaching of Zhang in Dalton transactions 2012, 41, 9119-9134, where polymerization of the sterically encumbering monomer furfuryl methacrylate was deemed to be impossible.

TABLE 2
Polymerization of furfuryl methacrylate

| | | | | | | | | Mₙ | |
|---|---|---|---|---|---|---|---|---|---|
| | | | [Base]/ | [Monomer]/ | Temp | t | Yield^{[a]} | [B] | PDI |
| Run | Acid | Base | [Acid] | [Cat] | [° C.] | [min] | [%] | [g/mol] | [B] |
| 7 | Al(Ph)₃ | PCy₃ | 0.5 | 100 | RT | 60 | 84 | 61000 | 1.38 |
| 8 | Al(Me)₃ | P(Et)₃ | 0.5 | 100 | RT | 60 | 88 | 120000 | 1.16 |

^{[a]}Yields determined by ¹H-NMR spectroscopy of sample aliquots and of the isolated polymers determined by using gravimetric methods.
[B] Mₙ and PDI determined using multi angle laser light scattering (MALLS) detection methods.

### Example 7

Further polymerization reactions were performed analoguously as described in example 5 using tert.-butylmethacrylate as monomer and using different bases. The results are shown in the table 3. As can be seen in table 3, polymerization results depend on the type of Lewis base used. The more sterically demanding the base is the higher the molecular mass of the obtained polymer will be. These results reveal the crucial importance of the implied Lewis Base (Run 9-11). The molecular mass of the produced polymers can be controlled by the sterical encumbrance of the used phosphine. This shows that the system of acid/base/monomer can be adjusted to get a polymer with desirable properties regarding molecular mass and/or PDI, with at the same time high TOF.

TABLE 3
Polymerization of tert.-butylmethacrylate

| | | | | | | | | Mₙ | |
|---|---|---|---|---|---|---|---|---|---|
| | | | [Base]/ | [Monomer]/ | Temp | t | Yield^{[a]} | [B] | PDI |
| Run | Acid | Base | [Acid] | [Cat] | [° C.] | [min] | [%] | [g/mol] | [B] |
| 9 | Al(Me)₃ | PMe₃ | 0.5 | 200 | RT | 90 | 100 | 61370 | 1.00 |
| 10 | Al(Me)₃ | P(nBu)₃ | 0.5 | 200 | RT | 90 | 100 | 120000 | 1.08 |
| 11 | Al(Me)₃ | PCy₃ | 0.5 | 200 | RT | 90 | 100 | 475000 | 1.07 |

^{[a]}Yields determined by ¹H-NMR spectroscopy of sample aliquots and of the isolated polymers determined by using gravimetric methods.
[B] Mₙ and PDI determined using multi angle laser light scattering (MALLS) detection methods.

1. A process for precision polymerization using a catalyst system of a Lewis acid and a Lewis base, with a Michael-type monomer that can form a frustrated triple, wherein
a) the Michael-type monomer, optionally dissolved in an organic solvent, is reacted with the Lewis acid to form at least one zwitterionic type complex,
b) the Lewis base is added to form a frustrated triple with the at least one zwitterionic type complex which initiates a polymerization reaction, and
c) the polymerization reaction is continued to form a polymer;
wherein the Lewis acid is XₐMR₃₋ₐ, wherein M is Al, B, Ga, or In, each X independently is Cl, F, I, or Br; each R independently is linear, branched, or cyclic alkyl, heterocycloalkyl, linear, branched, or cyclic alkenyl, heterocyclo-alkenyl, linear, branched, or cyclic alkinyl, heterocycloalkinyl, linear, branched, or cyclic alkoxy, aryl, heteroaryl, aryloxy, silyl, metallocenyl, nitro, nitroso, hydroxy, or carboxyl, wherein each alkyl, alkenyl or alkinyl group independently has up to 12 carbon atoms, wherein each aryl independently has 6 to 10 carbon atoms, wherein any hetero group has at least one hetero atom selected from the group consisting of O, S and N; wherein each alkyl, alkenyl, alkinyl, or alkoxy, heterocycloalkyl, heterocycloalkenyl, heterocycloalkinyl, aryl, heteroaryl, aryloxy group can be substituted by 1 up to the highest possible number of halogen atoms or by at least one unsubstituted or halogensubstituted linear, branched or cyclic alkyl group having up to 6 carbon atoms, and wherein a is an integer from 0 to 3, and wherein if a is 1, X can also be selected to be hydrogen; and wherein the Lewis base is PZ₃, wherein each Z independently is a linear, branched, or cyclic alkyl, alkenyl, or alkinyl group, or heteroalkyl, heteroal-kenyl, or heteroalkinyl group, having up to 12 carbon atoms; or a donor substituted aryl or hetero aryl group having 6 to 10 carbon atoms, with the proviso that the tolman angle is 180° or less; wherein any hetero group comprises at least one hetero atom selected from the group consisting of O, S and N.

2. Process according to claim 1, wherein the at least one Michael-type monomer is polymerized in the presence of a frustrated Lewis pair of a Lewis acid and a Lewis base, wherein the monomer has the formula C(R¹R²)═C(R³)—C(O)—OR⁴, wherein R¹, R², R³, and R⁴ are independently selected from the group consisting of hydrogen, methyl, aryl, heteroaryl and a bulky group, and wherein at least one of R¹ to R⁴ is the bulky group, or wherein the monomers are aerylonitrile, vinylsulfonates, vinylpyridines or vinylphosphonates wherein the process comprises that the monomer is contacted with the catalyst.

3. Process according to claim 1, wherein the Lewis acid is triphenyl aluminum, trimethyl aluminum, tri-isobutyl aluminum, or aluminum isopropoxide.

4. Process according to claim 1, wherein the Lewis base is trime-thylphosphine, triethylphosphine or tricyclohexylphosphine.

5. Process according to claim 1, wherein the molar ratio of Lewis base/Lewis acid is in a range between 0.1-0.5:1.

6. Process according to claim 1, wherein the molar ratio of monomer/catalyst system is 1,000 to 15,000.

7. Process according to claim 1, wherein the process is carried out at a temperature between −115° C. and +150° C.

8. Process according to claim 1, wherein the monomer is acrylonitrile or tert.-butylmethacrylate.

9. Process according to claim 1, wherein the monomer is acrylonitrile and wherein the catalyst system comprises triphenylaluminum and trimethylphosphine.

10. Process according to claim 1, wherein the monomer is tert.-butylmethacrylate and wherein the catalyst system comprises trimethylphosphine and trimethylaluminum.

11. Polymer produced by the process of claim 1.

12. System for precision polymerization comprising
a) a Michael-type monomer,
b) a Lewis acid XₐMR₃₋ₐ, as catalyst, and
c) a Lewis base PZ₃ as initiator,
d) and optionally a solvent
wherein components a), b), and c) can form a frustrated triple,
wherein X, M, R, Z, and a are defined as in claim 1.

13. Catalyst system for precision polymerization of acrylonitrile comprising tri-phenylaluminum and trimethylphosphine in a ratio of 4:1 to 1:1.

14. (canceled)

15. A method for identifying a frustrating triple system comprising the steps of
a) determining the electronic state of a Michael-type monomer,
b) choosing a Lewis acid based on its acidity, wherein the acidity is the higher the lower the electron richness of the monomer is,
c) combining the Michael-type monomer and the Lewis acid and adding a Lewis base and d) determining if a polymer with predetermined properties has formed as indication for the formation of the frustrated triple.
